(19) United States
(12) Patent Application Publication
(10) Pub. No.: US 2016/0094812 A1
(43) Pub. Date: Mar. 31, 2016

(54) Method And System For Mobile Surveillance And Mobile Infant Surveillance Platform

(71) Applicant: Kai Chen, Guangzhou (CN)

(72) Inventor: Kai Chen, Guangzhou (CN)

(21) Appl. No.: 14/503,111

(22) Filed: Sep. 30, 2014

(51) Int. Cl. H04N 7/18; H04R 1/32

(52) U.S. Cl. CPC H04N 7/183; H04R 1/326

(57) ABSTRACT

A method and system for mobile surveillance and a mobile infant surveillance platform are disclosed. The system includes a monitoring objective localization module, configured to acquire audio signal and obtain location information of the monitoring objective through the audio signal; a control unit, configured to generate a moving command for controlling the moving of a surveillance platform based on the location information of the monitoring objective; and a driving device, configured to drive the surveillance platform to move, based on the moving command. The present disclosure can implement mobile surveillance by driving a surveillance platform, which significantly improves the surveillance efficiency and has a high agility. In addition, the system can locate a monitoring objective through an audio signal that when the monitoring objective cannot be detected by a camera, infrared sensor or other device, the monitoring objective can be also accurately located, to provide a guideline for a surveillance platform to find the monitoring objective. The present disclosure thus can widely used in infant monitoring, handicapped monitoring and other fields.

### FIELD

The present disclosure relates generally to wireless surveillance technology, and more particularly, to a method and system for mobile surveillance and a mobile infant surveillance platform.

### BACKGROUND

Surveillance systems have been used in more and more applications in daily life at present, which have played an important role in different fields. For example, when parents leave their infant alone in a room, in order to ensure the parents to keep well informed of the infant, a surveillance system can be provided in the room to reflect the activities of the infant to the parents. However, the existing surveillance systems are generally designed for a fixed surveillance platform, such as the above infant surveillance system in which the surveillance platform is usually placed at a fixed location, which is inconvenience for the use of the parents. In addition, the infant is active that it often crawls or runs in the room, so the fixed surveillance platform does not really meet the requirement of surveillance well due to its small surveillance area, and low surveillance efficiency and agility. In conclusion, the existing surveillance systems cannot meet the requirement of surveillance.

### SUMMARY

In view of the above, in order to solve the technical problem existing in the prior art, it is an object of the present disclosure to provide a system for mobile surveillance which obtains location information of a monitoring objective through an audio signal and drives the surveillance platform to move to the monitoring objective, with a significant improvement in surveillance efficiency and a high agility.

According to an aspect of the disclosure, a system for mobile surveillance includes:

a monitoring objective localization module, configured to acquire audio signal and obtain location information of the monitoring objective through the audio signal;

a control unit, configured to generate a moving command for controlling the moving of a surveillance platform based on the location information of the monitoring objective; and

a driving device, configured to drive the surveillance platform to move, based on the moving command.

It is another object of the present disclosure to provide a mobile infant surveillance platform including the above system for mobile surveillance.

It is still a further object of the present disclosure to provide a method for mobile surveillance.

According to another aspect of the disclosure, a method for mobile surveillance includes:

acquiring audio signal, and obtaining location information of the monitoring objective through the audio signal;

generating a moving command for controlling the moving of a surveillance platform based on the location information of the monitoring objective; and

driving the surveillance platform to move, based on the moving command.

Compared with the prior art, the system for mobile surveillance according to the present disclosure can implement mobile surveillance by driving a surveillance platform, which significantly improves the surveillance efficiency and has a high agility. In addition, the system can locate a monitoring objective through an audio signal that when the monitoring objective cannot be detected by a camera, infrared sensor or other device, the monitoring objective can be also accurately located, to provide a guideline for a surveillance platform to find the monitoring objective. The present disclosure thus can widely used in infant monitoring, handicapped monitoring and other fields.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIG. 1 is a schematic diagram illustrating a system for mobile surveillance in accordance with certain embodiments of the present disclosure.

FIG. 2 is a schematic diagram illustrating a monitoring objective localization module in accordance with certain embodiments of the present disclosure.

FIG. 3 is a schematic diagram illustrating a system for determining whether the surveillance platform is targeting a monitoring objective in accordance with certain embodiments of the present disclosure.

FIG. 4 is a flow diagram illustrating a method for mobile surveillance in accordance with certain embodiments of the present disclosure.

FIG. 5 is a flow diagram illustrating a method for obtaining location information of a monitoring objective in accordance with certain embodiments of the present disclosure.

FIG. 6 is a flow diagram illustrating a method for determining whether the surveillance platform is targeting a monitoring objective in accordance with certain embodiments of the present disclosure.

FIG. 7 is a block diagram illustrating a computer system for accomplishing one embodiment of the present disclosure.

### DETAILED DESCRIPTION OF THE PREFERRED EMBODIMENTS

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Consider the following embodiments focusing on a surveillance of an infant, shown a system for mobile surveillance described herein.

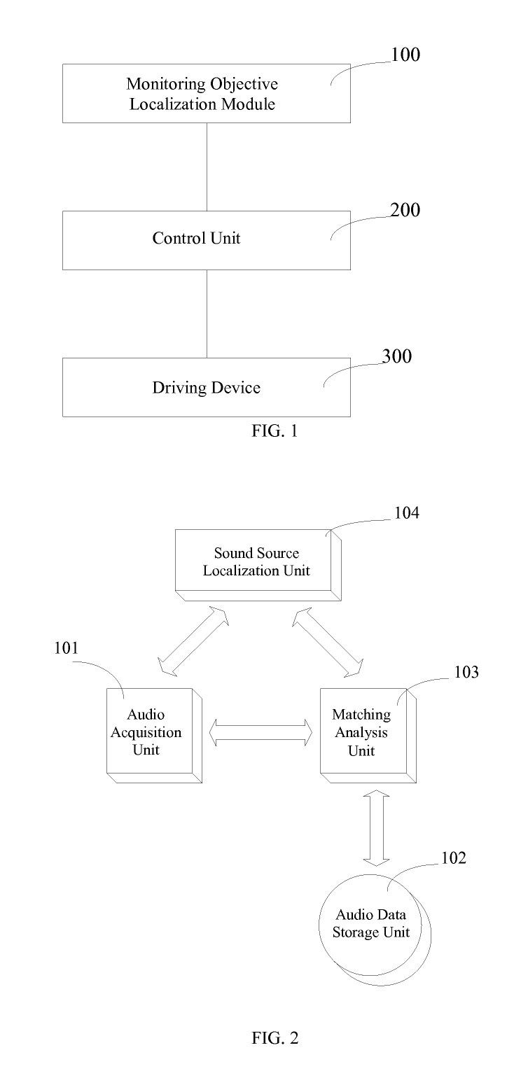

FIG. 1 is a schematic diagram illustrating a system for mobile surveillance in accordance with certain embodiments of the present disclosure. As shown in FIG. 1, the system for mobile surveillance includes:

a monitoring objective localization module 100, configured to acquire audio signal and obtain location information of the monitoring objective through the audio signal;

a control unit 200, configured to generate a moving command for controlling the moving of a surveillance platform based on the location information of the monitoring objective; and

a driving device 300, configured to drive the surveillance platform to move, based on the moving command.

In one embodiment, the monitoring objective may be an infant. The monitoring objective localization module 100 may be configured to acquire an audio signal. When the infant is laughing or crying, the monitoring objective localization module 100 may acquire a laugh or a cry from the infant, and determine the direction and distance of the infant through the laugh or cry from the infant to locate the infant to obtain location information of the infant. The control unit 200 may generate a moving command based on the location information of the infant obtained by the monitoring objective localization module 100, wherein the moving command may include direction information and/or distance information. The driving device 300 may receive the moving command and drive the surveillance platform to move based on the moving command. The surveillance platform is a mobile device which may move in response to the driving device 300 according to the moving command. This kind of mobile surveillance allows one single surveillance platform to cover a broader area and have a significant improvement in surveillance efficiency.

In the embodiment, the system for mobile surveillance may further includes a camera, infrared sensor or other devices configured to search for location information of the infant by video, infrared information or others to capture location information of the infant.

Compared with a camera or infrared sensor, the monitoring objective localization module 100 in the embodiment may implement the objective infant localization through an audio signal (such as a laugh or cry from the infant), and may accurately locate the objective infant when the infant cannot be detected by a camera, infrared sensor or other device, to provide a guideline for the surveillance platform to find the infant, resulting in significant effects.

In order to eliminate the influence of noise in the environmental to make the localization of the monitoring objective more accurately, a specific structure of the monitoring objective localization module 100 is described herein, which is illustrated in FIG. 2.

As shown in FIG. 2, in the embodiment, the monitoring objective localization module 100 includes:

an audio acquisition unit 101, configured to acquire an audio signal in the environment;

an audio data storage unit 102, configured to store audio data;

a matching analysis unit 103, configured to carry out a matching analysis between the audio signal acquired by the audio acquisition unit and the audio data stored in the audio data storage unit, to determine whether the audio signal matches the audio data; and

a sound source localization unit 104, configured to carry out a sound source localization based on the audio signal acquired by the audio acquisition unit 101 to obtain location information of the monitoring objective, when the matching analysis unit 103 determines the audio signal matches the audio data.

Continue to consider the following embodiments focusing on a surveillance of an infant, shown how a monitoring objective localization module 100 obtains location information of a infant through an audio signal.

In one embodiment, the monitoring objective localization module 100 includes an audio acquisition unit 101, an audio data storage unit 102, a matching analysis unit 103 and a sound source localization unit 104, wherein the audio acquisition unit 101 may be configured to acquire an audio signal in the environment. Preferably, the audio acquisition unit 101 may be a microphone array in one embodiment.

The microphone array may be an array of two or more microphones arranged in a certain geometric structure. The microphone array may obtain a better directivity compared with one single microphone, in the action of tiny time difference of the audio signal arrived at different microphones in the array. The microphone array has a strong inhibitory effect on far-field interference noise and is good at acquiring audio signal in noisy environment, so the microphone array may be used as the audio acquisition unit in a preferred embodiment.

The audio data storage unit 102 may store audio data in advance depending on surveillance requirements. In the embodiment, the audio data storage unit 102 may store information of laugh or cry of the objective infant in advance.

After an audio signal in the environment is acquired by the audio acquisition unit 101, the matching analysis unit 103 will carry out a matching analysis between the acquired audio signal and the information of laugh or cry of the objective infant pre-stored in the audio data storage unit 102, wherein a voice identification algorithm in the prior art, such as similarity identification algorithm or speech recognition, may be used as an algorithm for matching analysis to obtain the determination on consistence of the acquired audio signal and the pre-stored information of laugh or cry of the objective infant to determine whether the audio signal matches the pre-stored information. If the audio signal matches the pre-stored information, it means that the audio signal acquired by the audio acquisition unit 101 is generated by the objective infant, and in this case, a sound source localization is carried out to obtain location information of the objective infant based on the audio signal. And if the audio signal does not match the pre-stored information, it means that the audio signal is inconsistent with the pre-stored information of laugh or cry of the objective infant, and in this case, it further means that the audio signal may be a noise signal in the environment. Preferably, in order to achieve a better effect of monitoring, the system for mobile surveillance may provided with a warning module configured to send a warning message to a control terminal of the surveillance platform which may be informed and decide whether to locate the sound source in the subsequent process when the above mismatch exists. In addition, the warning module may be also configured to send an alarm message indicating crying of a infant to the control terminal of the surveillance platform according to the actual needs of surveillance, and specifically, when using the algorithm for matching analysis, by the matching analysis unit 103, and concluding that the audio signal acquired by the audio acquisition unit 101 matches the information of cry of the objective infant stored in the audio data storage unit 102, the warning module may send an alarm message to the control terminal of the surveillance platform to inform a parent at the control terminal that the infant is crying, in order to take corresponding means.

The sound source localization unit 104 may be configured to carry out a sound source localization based on the audio signal to obtain location information of the monitoring objective. When locating the sound source, one of localization methods in the prior art may be used. In one embodiment, the audio acquisition unit 101 may use a microphone array, and the localization method may be a steered beamformer approach to source localization based the maximum power output, in which the audio signal received by the microphones may be filtered and weightedly summed to form a beam, the beam may be guided by searching possible locations of the sound source, and the point to make the beam have the maximum power may be identified as the location of the sound source. The simplest way to do this is a method of Delay-and-Sumbeamforming (DSB) which uses a time shift for the signal from the microphone to compensate a propagation delay from the sound source to the microphone and obtains the output of the array by summing and averaging. A more complex beamforming method includes a method of filter-and-sumbeamforming (FSM) which filters the audio signal while correcting time.

A localization method based on Time Difference of Arrival (TDOA) in the prior art may also be used in the sound source localization unit 104, which is a method of localization of two steps. In this method, the time difference of the audio signal arrived at different microphones in the array may be estimated at first, and the location of the sound source may be determined by a geometrical relationship. The soundness of time delay estimation is the basis of a precise localization for the method. According to the different physical parameters to be used, the exiting method of time delay estimation may be divided into two categories:

1. methods for time delay estimation with a cross-correlation function, such as generalized cross correlation (GCC), maximum likelihood (ML), weighting, cross-power spectrum phase (CSP) and so on; and

2. methods to obtain TDOA estimation by calculating the impulse response (or transfer function) of paths, including: least mean square (LMS), eigenvalue decomposition (EVD), acoustic transferfunctions ratio (ATF ratio) and so on.

The distance difference may be obtained by multiplying the TDOA from the above by the sound velocity. In reference with the principle of binaural localization, energy attenuation of the audio signal during propagation may be calculated when the audio signal delay is extracted, so as to achieve the localization of the sound source by using a smaller number of microphones. The localization method based on time delay in the art has less calculation and can achieve good real-time performance in real systems.

Of course, the acoustic source localization unit 104 may also use other sound source location methods in the prior art; it is unnecessary to go into detail.

The sound source localization unit 104 may obtain the location information of the sound source after carrying out a sound source localization based on the audio signal acquired by the audio acquisition unit 101, to obtain the location information of the objective infant. The control unit 200 may generate a moving command for controlling the moving of a surveillance platform based on the location information of the objective infant obtained by the sound source localization unit. The driving device 300 may drive the surveillance platform to move towards the objective infant based on the moving command, to achieve the mobile surveillance of the infant.

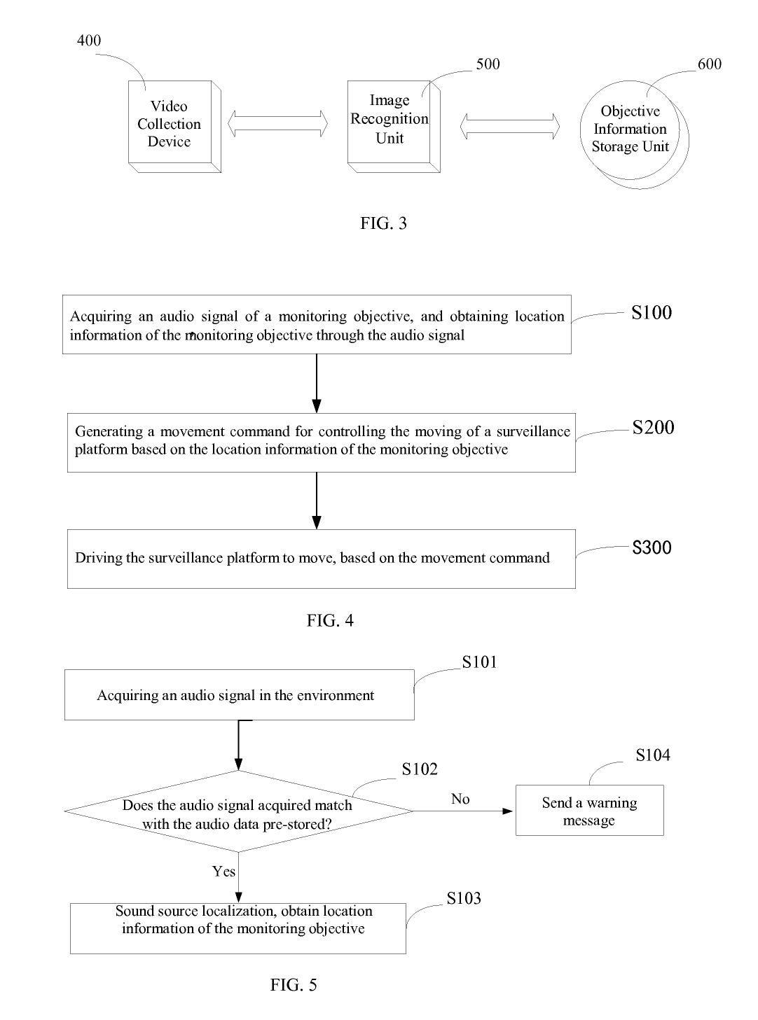

As shown in FIG. 3, the system for mobile surveillance may also provided with a video collection device 400, configured to collect video signals, in order to ensure the surveillance platform can target the monitoring objective. Face information of the monitoring objective corresponding to the monitoring objective may be pre-stored in an objective information storage unit 600. An image recognition unit 500 may also be provide to carry out a face detection based on the video information collected by the video collection device 400, and when face information is acquired by face detecting, a matching analysis may be made to the acquired face information and the face information of the monitoring objective pre-stored in the objective information storage unit 600, to determine whether the surveillance platform is targeting the monitoring objective.

Take for example the surveillance of an infant. In one embodiment, when the surveillance platform moves to a location at a certain distance (the distance may be affected by the above moving command or may be pre-determined) from the objective infant, the video collection device 400 may start to collect video information, and the image recognition unit 500 may divide the collected video information into frames to extract a frame of image from the video according to recognition methods in the prior art, to carry on noise reduction, filtering or other pre-processing, and use a face detection technology (for example, video face detection technology based on Adaboost algorithm) for face detection to detect face information in the present video. The face information of the objective infant has been pre-stored in the objective information storage unit 600. When a face is detected by the image recognition unit 500, a matching analysis may be made to the acquired face information and the face information of the objective infant pre-stored in the objective information storage unit 600 by the image recognition unit 500, to determine whether the two face information match, and if so, it means that the surveillance platform is targeting the objective infant that the surveillance platform may perform follow-up surveillance actions. And if a mismatch occurs or the face information is not detected, it means that the surveillance platform does not target the objective infant, so it needs to proceed to locate the objective infant and drive the surveillance platform to move towards the objective infant.

The image recognition unit 500 may extract features of face images based on a face recognition algorithm such as HiddenMarkov Model (HMM) for face matching when carries out the above matching analysis.

In addition, the system for mobile surveillance may also be provided with an infrared acquisition device including infrared sensor. The infrared acquisition device uses a method in the prior art to detect whether there is an objective infant by acquiring infrared information, so as to determine whether the surveillance platform is targeting the objective infant. The process will not be discussed here.

In one embodiment, after the surveillance platform is targeting the objective infant, the system for mobile surveillance may carry out the follow-up monitoring operation, for example, the video collection device 400 may start to collect video information, record a video of the objective infant, and record the precious moment of the infant to retain a memory of innocent childhood.

When video information is collected, the location of the surveillance platform may be adjusted according to the changes of location of the infant, to realize automatic tracking.

Specifically, the image recognition unit 500 may divide the video information of the objective infant collected by the video collection device 400 into frames, carry out a face detection to acquire face information, and determine the moving direction of the face of the objective infant based on the face information of images of multi-frame, the control unit 200 may generate a corresponding moving command according to the moving direction of the face of the objective infant, and the driving device 300 may drive the surveillance platform to move based on the moving command.

In addition, the image recognition unit 500 is also configured to acquire the moving range of the face of the objective infant. When the moving range of the face of the objective infant goes beyond the collection range of the video collection device, the control unit 200 may generate a corresponding moving command, the driving device 300 may drive the surveillance platform to move based on the moving command, and the monitoring objective localization module 100 may reacquire location information of the monitoring objective. Specifically, when using an existing technology to divide the video information into frames for face detecting the image recognition unit 500 may analyze the face information in images of multi-frame synthetically. When face information is detected in a part of frames and is not detected in other frames, which means that the range of the movement of the face of the objective infant goes beyond the collection range of the video collection device 400, the control unit 200 may generate a moving command, the driving device 300 may drive the surveillance platform to move based on the moving command, and the monitoring objective localization module 100 may start to obtain location information of the monitoring objective aobtain. The moving command described herein may be generated from a particular algorithm, or be pre-determined, such as being pre-determined to keep the original direction and move half of the distance from the present location of the surveillance platform to the location of the objective infant. The video collection device 400 may continue to collect video information during the movement of the surveillance platform.

Above all, the system for mobile surveillance described herein may control the surveillance platform to implement mobile surveillance to significantly improve the coverage of the surveillance platform and the surveillance efficiency. Audio signals may be acquired by the monitoring objective localization module to obtain location information of the monitoring objective that the monitoring objective may be accurately located when the monitoring objective cannot be detected by a camera, infrared sensor or other device, so as to provide a guideline for a surveillance platform to find the monitoring objective. Preferably, a sound source localization technology based on microphone array may be used to implement the localization of the monitoring objective exactly. The video collection device may record video information of the monitoring objective to record the actions of the monitoring objective, after the monitoring objective is targeted. In addition, the location of the surveillance platform may be adjusted by the system for mobile surveillance according to the changes of location of the monitoring objective, to realize automatic tracking. With the above beneficial effects, the system for mobile surveillance described herein can be widely used in a variety of surveillance applications to realize infant, handicapped or psychopath monitoring.

According to another aspect of the disclosure, a mobile infant surveillance platform according to the above system for mobile surveillance is provided. The mobile infant surveillance platform with the above system for mobile surveillance may implement mobile surveillance for an infant, and realize the location of the sound to obtain location information of the infant according to an audio signal. The mobile infant surveillance platform may automatically move to the infant, target the infant through a video collection device, record video information of the infant, and adjust its location according to the changes of location of the infant to realize automatic tracking. The implementation of the function in the mobile infant surveillance platform can refer to the above system for mobile surveillance, and then it is unnecessary to go into detail.

As shown in FIG. 4, according to a further aspect of the disclosure, a method for mobile surveillance is provided, including:

step S100, acquiring audio signal, and obtaining location information of the monitoring objective through the audio signal;

step S200, generating a moving command for controlling the moving of a surveillance platform based on the location information of the monitoring objective; and

step S300, driving the surveillance platform to move, based on the moving command.

Consider the following embodiments focusing on a surveillance of an infant, shown a method for mobile surveillance described herein.

In one embodiment, an audio signal in the environment may be acquired at first, which may be a cry or laugh from a infant. Location information of the infant may be obtained accurately by an audio analysis, which may include the distance and direction information of the infant. A moving command for controlling the moving of a surveillance platform may be generated according to the location information of the infant obtained, which may include direction information and/or distance information. The surveillance platform may be driven by a driving device of the surveillance platform based on the moving command, to move towards the location of the infant. The surveillance platform may be a mobile device. The method described allows one single surveillance platform to cover a broader area and have a significant improvement in surveillance efficiency.

The location information of the infant may be obtained by video information or infrared information. The process will not be discussed herein.

Compared with a method for obtaining location information of the infant by video information or infrared information, the method discussed herein may realize the localization of the infant through an audio signal, and may accurately locate the objective infant when the infant cannot be detected by a camera, infrared sensor or other device, to provide a guideline for the surveillance platform to find the infant, resulting in significant effects.

In order to eliminate the influence of noise in the environmental to make the localization of the monitoring objective more accurately, a method for obtaining the location information of the monitoring objective is described herein, and FIG. 5 is a flow diagram illustrating the method.

As shown in FIG. 5, in the embodiment, location information of a monitoring objective may be obtained by the followings:

step S101, acquiring an audio signal in the environment;

Preferably, use a microphone array to acquire the audio signal in the environment.

step S102, carrying out a matching analysis between the audio signal acquired and the audio data pre-stored, to determine whether the audio signal matches the audio data;

Audio data may be stored in advance depending on surveillance requirements. In the embodiment, information of laugh or cry of the objective infant may be pre-stored. A matching analysis between the audio signal acquired and the information of laugh or cry of the objective infant pre-stored may be made, wherein a voice identification algorithm in the prior art, such as similarity identification algorithm or speech recognition, may be used as an algorithm for matching analysis to obtain the determination on consistence of the acquired audio signal and the pre-stored information of laugh or cry of the infant to determine whether the audio signal matches the pre-stored information. If the audio signal matches the pre-stored information, it means that the audio signal acquired is generated by the infant and proceeding to step S103 in which the sound source localization is carried out to obtain location information of the objective infant based on the audio signal.

If the audio signal does not match the pre-stored information, it means that the audio signal is inconsistent with the pre-stored information of laugh or cry of the objective infant, and in this case, it further means that the audio signal may be a noise signal in the environment. Preferably, in order to achieve a better effect of monitoring, the method for mobile surveillance may enter step S104 when the above mismatch exists, to send a warning message to a control terminal of the surveillance platform which may be informed and decide whether to locate the sound source in the subsequent process.

step S103, carrying out a sound source localization based on the audio signal acquired to obtain location information of the monitoring objective, when the audio signal acquired matches the audio data pre-stored.

A localization method in the prior art, such as steered beamformer approach to source localization based the maximum power output or localization method based on TDOA, may be used for sound source localization. After the location of the sound source is obtained, the location information of the infant may be obtained.

In addition, an alarm message indicating crying of a infant may be sent to the control terminal of the surveillance platform according to the actual needs of surveillance. Specifically, the pre-stored audio data includes information of cry of the objective infant, and when a matching analysis is made by step S102 to conclude that the acquired audio signal matches the pre-stored information of cry of the objective infant, an alarm message may be sent to the control terminal of the surveillance platform to inform a user (such as a parent) at the control terminal that the infant is crying, in order to take corresponding means.

With the above method for mobile surveillance, the surveillance platform may know the location of the monitoring objective and move towards to the location of the monitoring objective.

In order to determine whether the surveillance platform has found the monitoring objective, a method for determining whether the surveillance platform is targeting the monitoring objective is described herein.

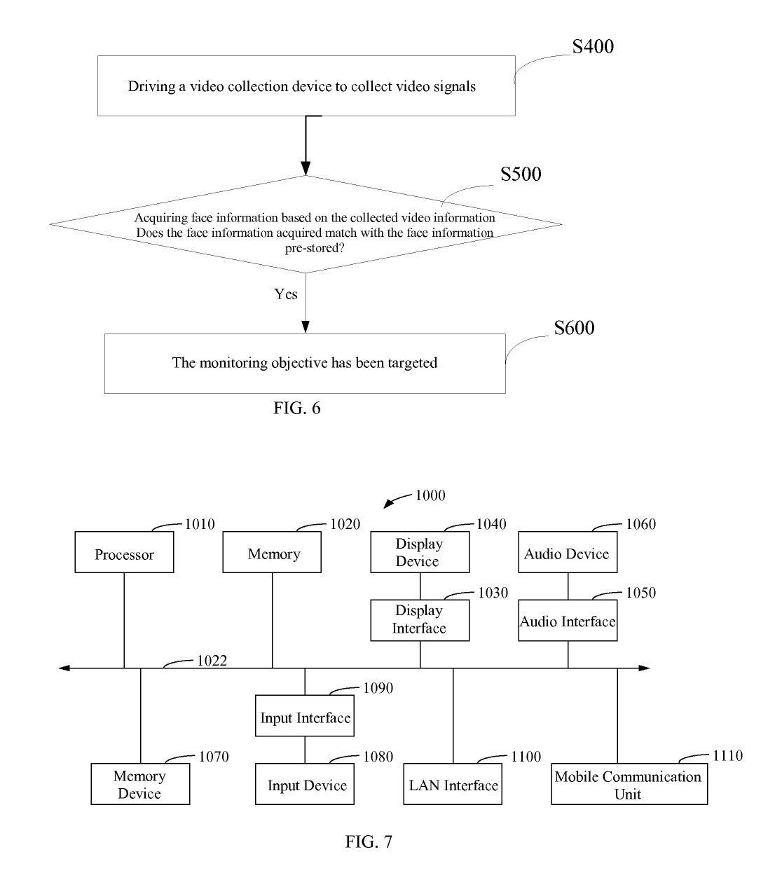

FIG. 6 is a flow diagram illustrating a method for determining whether the surveillance platform is targeting a monitoring objective. As shown in FIG. 6, the method includes:

step S400, driving a video collection device to collect video signals;

step S500, carrying out a face detection to acquire face information based on the collected video information, and making a matching analysis between the face information and pre-stored face information of the monitoring objective to determine whether the two face information match; and

step S600, determining the surveillance platform is targeting the monitoring objective when the above two face information match.

When the surveillance platform is moving according to the moving command, video information may be collected by a video collection device to detect the existence of the objective infant, in order to ensure the surveillance platform can target the objective infant. The detailed process is as followings

At first, face information of the objective infant corresponding to the objective infant to be monitored may be pre-stored.

When the surveillance platform moves to a location at a certain distance (the distance may be affected by the above moving command or may be pre-determined) from the objective infant, the video collection device may start to collect video information. A face detection algorithm in the prior art may be used to carry out a face detection based on the collected video information, to acquire face information. A matching analysis may be made to the acquired face information and the face information of the pre-stored objective infant, to determine whether the surveillance platform is targeting the infant by the result of the matching analysis.

If the above two face information match, it means that the surveillance platform is targeting the objective infant that the surveillance platform may perform follow-up surveillance actions, otherwise, it means that the surveillance platform does not target the objective infant, so it needs to proceed to reacquire location information of the objective infant.

When performing the above matching analysis, a face recognition algorithm in the prior art may be used to extract features of face images for face matching.

The video collection device may be driven to record the video information of the objective infant after the objective infant is targeted by the surveillance platform.

When video information of the objective infant is recorded, the location of the surveillance platform may be adjusted according to the changes of location of the infant, to realize automatic tracking. The detail process is as followings:

determining the moving direction of the face of the monitoring objective according to the acquired face information; and

generating a corresponding moving command according to the moving direction of the face of the monitoring objective, and driving the surveillance platform to move based on the moving command.

Specifically, the face detection algorithm in the prior art may divide the collected video information into frames to obtain a sequence of images to detect face information. The direction of the movement of the face of the objective infant may be determined according to the face information from the sequence of images. A corresponding moving command may be generated according to the direction of the movement of the face of the objective infant. The driving device of the surveillance platform may drive the surveillance platform to move according to the moving command. The moving command described herein may be generated from a particular algorithm, or be pre-determined.

It may further include:

determining the moving range of the face of the monitoring objective according to the acquired face information. When the moving range of the face of the objective infant goes beyond the collection range of the video collection device, an audio signal may be reacquired, and location information of the monitoring objective may be obtained according to the audio signal.

Specifically, when using a face detection algorithm in the prior art to divide the collected video information into frames to carry out a face detection, the face information in images of multi-frame may be analyzed synthetically. When face information is detected in a part of frames and is not detected in other frames, which means that the range of the movement of the face of the objective infant goes beyond the collection range of the video collection device, a corresponding moving command may be generated, the driving device of the surveillance platform may drive the surveillance platform to move based on the moving command, and the location information of the objective infant may be reacquired. The moving command described herein may be generated from a particular algorithm, or be pre-determined, such as being pre-determined to keep the original direction and move half of the distance from the present location of the surveillance platform to the location of the objective infant.

The method for mobile surveillance may be implemented by the above system for mobile surveillance, and it is unnecessary to go into detail.

Unless the context clearly requires otherwise, the number of a certain component or part described herein may be one or more, without limitation. Although the steps described herein are arranged during explaining, the order of the steps is not limited, and the order of the steps may be changed unless the order of the steps is clearly defined or the execution of a certain step is based on another step. It will be appreciated that the term of “and/or” used herein involves and contains any or all of possible combinations of one or more items listed.

It will be appreciated for those skilled in the art that parts of or overall process in the above embodiments can be implemented by related hardware controlled by computer program, the computer program can be stored in a non-transitory computer-readable storage medium, and when the computer program is executed, it can include the processes of the above embodiments of each method. Wherein, the non-transitory computer-readable storage medium can be a disc, a compact disc, a Read-Only Memory or a Random Access Memory. According to still a further aspect of the present disclosure, a computer-readable storage medium for storing computer executable instruction is also provided that when the computer executable instruction in the storage medium is executed, any one of the above methods for mobile surveillance can be implemented.

FIG. 7 is a block diagram illustrating a computer system 1000 for accomplishing one embodiment of the present disclosure. The computer system 1000 is only an example of computer environment adapted for the present disclosure, and cannot be considered as any limitation to the application of the present disclosure. The computer system 1000 cannot be interpreted as a combination of one or more parts in the exemplary computer system 1000.

The computer system 1000 shown in FIG. 7 is an example of computer system adapted for the present disclosure. The computer system 1000 may be implemented in a device selected from the group consisting of desktop, laptop, personal digital assistant, smart phone, tablet computer, portable media player and set top box.

As shown in FIG. 7, the computer system 1000 may include a processor 1010, a memory 1020 and a system bus 1022. The system components including the memory 1020 and the processor 1010 are connected to the system bus 1022. The processor 1010 is a hardware configured to execute computer program instructions via basic arithmetic and logical operations in the computer system. The memory 1020 is a physical device configured to store programs or data (for example, information about application state) in the computer permanently or temporarily. The system bus 1022 may be selected from the group consisting of memory bus, peripheral bus and local bus. The processor 1010 may communicate with the memory 1020 by the system bus 1022. The memory 1020 may include a read-only memory (ROM), a flash memory (not shown), or a random access memory (RAM), wherein the RAM generally means a main memory loading an operating system and an application program.

The computer system 1000 may also include a display interface 1030 (for example, graphics processing unit), a display device 1040 (for example, liquid crystal display), an audio interface 1050 (for example, sound card) and an audio device 1060 (for example, loudspeaker). The display device 1040 and the audio device 1060 are media devices for multimedia experience.

The computer system 1000 generally includes a memory device 1070. The memory device 1070 may selected from various computer readable mediums. The computer readable medium means any available medium accessed by the computer system 1000, including a removable medium and a fixed medium. The computer readable medium includes but is not limited to flash memory (micro SD card), CD-ROM, Digital Versatile Disc (DVD), magnetic tape, disk storage, or any other medium available for storing the needed information and accessed by the computer system 1000.

The computer system 1000 may also include an input device 1080 and an input interface 1090 (for example, I/O controller). The user may input commands and information to the computer system 1000 by the input device 1080, such as keyboard, mouse or touch panel on the display device 1040. The input device 1080 is generally connected to the system bus 1022 by the input interface 1090 or other interfaces or bus structures, such as Universal Serial Bus (USB).

The computer system 1000 may have a logical connection to one or more network devices in the networked environment. The network device may be a personal computer, a server, a router, a smart phone, a tablet computer or other public network node. The computer system 1000 is connected to the network device by a local area network (LAN) interface 1100 or a mobile communication unit 1110. The LAN is a computer network that interconnects computers within a limited area such as a home, school, computer laboratory, or office building, using network media. The two most common technologies to build a local area network are Wi-Fi and Ethernet over twisted pair. Wi-Fi allows the computer system 1000 to exchange data or connect to the internet using radio waves. The mobile communication unit 1110 may make and receive calls via a radio link while moves in a wide geographic area. Apart from calling, internet access in a 2G, 3G or 4G cellular system providing mobile data services is also supported by the mobile communication unit 1110.

It should be noted that a computer system including more or less subsystems than the computer system 1000 may also be used in the present disclosure. For example, the computer system 1000 may include a Bluetooth communication unit available for data exchange over a short distance, an imaging sensor for photographing and a accelerometer for acceleration measurement.

As mentioned above, the computer system 1000 adapted for the present disclosure may perform the specified operations of the above method for mobile surveillance. These operations are performed by the computer system 1000 in the form that the processor 1010 run software instructions stored in the computer readable medium. These software instructions may be read from the memory device 1070 into the memory 1020, or from another apparatus into the memory 1020 via a LAN interface.

The above embodiments are chosen and described in order to explain the principles of the disclosure and their practical application so as to activate those skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

1. A system for mobile surveillance, comprising:
a monitoring objective localization module, configured to acquire audio signal and obtain location information of the monitoring objective through the audio signal;
a control unit, configured to, based on the location information of the monitoring objective, generate a moving command for controlling the moving of a surveillance platform; and
a driving device, configured to, based on the moving command, drive the surveillance platform to move.

2. The system of claim 1, wherein the monitoring objective localization module comprises:
an audio acquisition unit, configured to acquire an audio signal in the environment;
an audio data storage unit, configured to store audio data;
a matching analysis unit, configured to carry out a matching analysis between the audio signal acquired by the audio acquisition unit and the audio data stored in the audio data storage unit, to determine whether the audio signal matches the audio data; and
a sound source localization unit, configured to carry out a sound source localization based on the audio signal acquired by the audio acquisition unit 101 to obtain location information of the monitoring objective, when the matching analysis unit 103 determines that the audio signal matches the audio data.

3. The system of claim 2, wherein the audio acquisition unit comprises a microphone array.

4. The system of claim 2, further comprising a warning module, configured to send a warning message to a control terminal of the surveillance platform.

5. The system of claim 1, further comprising:
a video collection device, configured to collect video signals;
an objective information storage unit, configured to store face information; and
an image recognition unit, configured to carry out a face detection based on the video information collected by the video collection device, and when face information is acquired by the face detection, make a matching analysis between the acquired face information and the face information of the monitoring objective pre-stored in the objective information storage unit, to determine whether the surveillance platform is targeting the monitoring objective.

6. The system of claim 5, further comprising an infrared acquisition device, configured to determine whether the surveillance platform is targeting the monitoring objective by acquiring infrared information.

7. The system of claim 5, wherein the image recognition unit is also configured to obtain the moving direction of the face of the monitoring objective, the control unit generates a corresponding moving command according to the moving direction of the face of the objective infant, and the driving device drives the surveillance platform to move based on the moving command.

8. The system of claim 7, wherein the image recognition unit is also configured to acquire the moving range of the face of the monitoring objective, and when the moving range of the face of the objective infant goes beyond the collection range of the video collection device, the control unit generates a corresponding moving command, the driving device drives the surveillance platform to move based on the moving command, and the monitoring objective localization module reacquires location information of the monitoring objective.

9. A mobile infant surveillance platform comprising the system for surveillance platform of claim 1.

10. A method for mobile surveillance, comprising:
acquiring audio signal, and obtaining location information of the monitoring objective through the audio signal;
generating a moving command for controlling the moving of a surveillance platform based on the location information of the monitoring objective; and
driving the surveillance platform to move based on the moving command.

11. The method of claim 10, wherein the acquiring comprises:
carrying out a matching analysis between the audio signal acquired and the audio data pre-stored, to determine whether the audio signal matches the audio data; and
carrying out a sound source localization based on the audio signal acquired to obtain location information of the monitoring objective, when the audio signal acquired matches the audio data pre-stored.

12. The method of claim 10, further comprising:
driving a video collection device to collect video signals;
carrying out a face detection to acquire face information based on the collected video information, and making a matching analysis between the face information acquired and pre-stored face information of the monitoring objective to determine whether the two face information match each other; and
determining that the surveillance platform is targeting the monitoring objective when the above two face information match each other.

13. The method of claim 12, after the surveillance platform is targeting the monitoring objective, further comprising:
determining the moving direction of the face of the monitoring objective according to the acquired face information; and
generating a corresponding moving command according to the moving direction of the face of the monitoring objective, and driving the surveillance platform to move based on the moving command.

14. The method of claim 13, further comprising:
determining the moving range of the face of the monitoring objective according to the acquired face information; when the moving range of the face of the objective infant goes beyond the collection range of the video collection device, reacquiring audio signal, and obtaining location information of the monitoring objective according to the audio signal.

15. The system of claim 11, further comprising:
sending a warning message to a control terminal of the surveillance platform when the audio signal acquire does not match the audio data pre-stored.

16. The method of claim 11, further comprising:
sending an alarm message to a control terminal of the surveillance platform, when the pre-stored audio data includes information of cry of the monitoring objective and the acquired audio signal matches the pre-stored information of cry of the objective.
